(19) United States
(12) Patent Application Publication
(10) Pub. No.: US 2026/0084981 A1
(43) Pub. Date: Mar. 26, 2026

(54) WATER DISPENSING DEVICE

(71) Applicant: LG ELECTRONICS INC., Seoul (KR)

(72) Inventors: Sangjoon LEE, Seoul (KR); Kowoon BAEK, Seoul (KR); Yuri CHOI, Seoul (KR); Minyoung PARK, Seoul (KR)

(21) Appl. No.: 19/112,319

(22) PCT Filed: Sep. 7, 2023
(86) PCT No.: PCT/KR2023/013395

§ 371 Date: Mar. 17, 2025

(30) Foreign Application Priority Data
Sep. 19, 2022 (KR) 10-2022-0117730

(51) Int. Cl. C02F 1/00; C02F 1/02; C02F 1/32

(52) U.S. Cl. CPC C02F 1/001; C02F 1/02; C02F 1/32; C02F 2201/005; C02F 2209/003; C02F 2209/11; C02F 2303/04; C02F 2307/10

(57) ABSTRACT

A water dispensing device according to an embodiment of the present disclosure may comprise: a water supply passage through which raw water supplied from a water supply source flows; a filter which filters raw water supplied through the water supply passage to produce purified water; a purified water passage through which purified water having passed through the filter flows; a water quality measurement unit which is connected to the purified water passage and measures the water quality of the purified water; a sterilization passage, one side of which is diverged from the water supply passage and the other side of which is connected to the filter; and a sterilization module which is provided on the sterilization passage to heat water passing through the sterilization passage, wherein, on the basis of water quality data measured by the water quality measurement unit, high temperature water discharged from the sterilization module is moved to different passage regions to perform a sterilization operation for each passage region.

### TECHNICAL FIELD

The present disclosure relates to a water dispensing device and an operating method thereof, and more particularly, to a water dispensing device including a sensor capable of discriminating a water quality, and an operating method thereof.

### BACKGROUND ART

A water dispensing device supplies water and may take out a desired amount of water at a desired temperature according to the manipulation of a user. The water dispensing device as such may be applied to various fields, but may be applied representatively to a refrigerator and a water purifier. In particular, the water dispensing device provided in the refrigerator and the water purifier is configured to have a function that enables supplying of a preset amount of water according to the manipulation of a user. Recently, for these water dispensing devices, the water dispensing devices that may supply not only purified water but also cold and hot water have been developed.

For example, a water purifier is connected to a water supply source such as a tap to receive raw water, uses a filter to remove floating matters or harmful substances contained in the raw water, and is configured to purify and take out a desired amount of water according to the manipulation of a user. A variety of water purifier products are being released that may purify water as well as heat or cool the purified water to supply cold or hot water. In addition, recently, water purifiers that are small in size and may be installed in various installation environments are being developed.

In a case where the water dispensing device is used for a long time, microorganisms or the like may be propagated in or contaminate pipes, valves, or water outlets. In addition, due to the elapse of the replacement cycle of a filter, floating matters or harmful substances contained in raw water may not be removed. Accordingly, it is important for the water dispensing device to accurately measure water quality, perform hygienical management, and also manage water purification quality performance.

The related art of Korean Patent Application Publication No. 10-2011-0109747 relates to a sterilizing apparatus of an internal passage in a water purifier, wherein the apparatus includes: a sterilization module that produces sterilization water; a purified water tank where the sterilization water is stored; lines for an inflow/outflow of the sterilization water and a circulation pump that allow the sterilization water to circulate through the internal passage of the water purifier; and a control unit that controls the sterilization module using a timer. By circulating the sterilization water, the entire internal passage of the water purifier may be sterilized. The related art of Korean Patent Application Publication No. 10-2011-0109747 is configured to sterilize the entire region by circulating the sterilization water, wherein the sterilization time is long and inefficient due to timer-based control.

### DISCLOSURE

### Technical Problem

An aspect of the present disclosure is directed to providing a water dispensing device capable of efficiently sterilizing a passage in a short period of time.

Another aspect of the present disclosure is directed to providing a water dispensing device capable of automatically sensing water quality abnormalities and sterilizing water to hygienically manage a passage.

Yet another aspect of the present disclosure is directed to providing a water dispensing device capable of selectively sterilizing a passage in response to water quality measurement results.

Yet another aspect of the present disclosure is directed to providing a water dispensing device capable of accurately measuring the water quality of raw water and purified water.

Yet another aspect of the present disclosure is directed to providing a water dispensing device capable of improving sensing accuracy and efficiency by a water pipe configuration and a rinse operation for sensor publicization.

### Technical Solution

A water dispensing device according to an embodiment of the present disclosure may include: a water supply passage through which raw water supplied from a water supply source flows; a filter which filters raw water supplied through the water supply passage to produce purified water; a purified water passage through which purified water having passed through the filter flows; a water quality measurement unit which is connected to the purified water passage and measures the water quality of the purified water; a sterilization passage, one side of which is diverged from the water supply passage and the other side of which is connected to the filter; and a sterilization module which is provided on the sterilization passage to heat water passing through the sterilization passage, wherein, on the basis of water quality data measured by the water quality measurement unit, high temperature water discharged from the sterilization module is moved to different passage regions to perform a sterilization operation for each passage region.

The water dispensing device according to an embodiment of the present disclosure may further include: a water outlet through which the purified water is discharged; a water outlet passage guiding the purified water to the water outlet; and a drainage passage diverged from the water outlet passage between the water quality measurement unit and the water outlet through which the raw water or the purified water is drained.

The water dispensing device according to an embodiment of the present disclosure may further include a water outlet valve selectively supplying the raw water or the purified water to the water outlet passage and the drainage passage.

The water dispensing device according to an embodiment of the present disclosure may further: a hot water passage diverged from the purified water passage at one side; a hot water module provided in the hot water passage to heat purified water passing through the hot water passage; a cold water passage diverged from the purified water passage at one side; and a cold water module provided in the cold water passage to cool purified water passing through the cold water passage.

When the water quality data measured by the water quality measurement unit is higher than a first reference value, the purified water passage may be sterilized with the high temperature water discharged from the sterilization module.

When the water quality data measured by the water quality measurement unit is higher than a second reference value that is higher than the first reference value, the purified water passage and the water outlet passage may be sterilized with the high temperature water discharged from the sterilization module.

When the water quality data measured by the water quality measurement unit is higher than a third reference value that is higher than the second reference value, the entire passage may be sterilized with the high temperature water discharged from the sterilization module.

When the water quality data measured by the water quality measurement unit is higher than the first reference value, discharge of the water outlet may be stopped.

The hot water passage and the cold water passage may be joined to the water outlet passage or joined again to the purified water passage.

The water dispensing device according to an embodiment of the present disclosure may further include a water outlet sterilization module that irradiates ultraviolet rays to the water outlet, wherein the water outlet sterilization module may operate for a predetermined time based on the water quality data measured by the water quality measurement unit.

The water dispensing device according to an embodiment of the present disclosure may further include a drainage pump disposed in the drainage passage.

The drainage pump may operate while the sterilization operation is performed for each of the passage regions.

The water quality measurement unit may re-measure the water quality after performing the sterilization operation for each of the passage regions.

The water dispensing device according to an embodiment of the present disclosure may further include an output unit that displays water quality abnormality information when the water quality re-measurement result is outside a preset normal range.

The water dispensing device according to an embodiment of the present disclosure may further include a sensing passage diverged from the water supply passage and through which the raw water flows, wherein the water quality measurement unit may measure the water quality of the purified water when the purified water enters through the purified water passage and may measure the water quality of the raw water when the raw water enters through the sensing passage.

The water quality measurement unit may measure the water quality of the purified water after performing a rinse operation in which the purified water passes through at least once when measuring the water quality of the raw water.

The water dispensing device according to an embodiment of the present disclosure may further include a switching valve for supplying the raw water to the water supply passage or the sterilization passage, and a sensing valve for opening and closing the sensing passage.

The water dispensing device according to an embodiment of the present disclosure may further a control unit that controls to perform a feedback operation based on the water quality data measured by the water quality measurement unit.

The water quality measurement unit may include a turbidity sensor that irradiates light to the raw water or a portion of the purified water and senses turbidity based on a pattern of scattered light received.

### Advantageous Effects

According to at least one of the embodiments of the present disclosure, a passage can be efficiently sterilized in a short period of time.

According to at least one of the embodiments of the present disclosure, water quality abnormalities can be automatically sensed and sterilized to hygienically manage the passage.

According to at least one of the embodiments of the present disclosure, the passage can be selectively sterilized in response to water quality measurement results.

According to at least one of the embodiments of the present disclosure, the sensing accuracy and efficiency can be improved by a water pipe configuration and a rinse operation for sensor publicization.

Various other benefits will be described directly or implicitly in the detailed description according to the embodiments of the present disclosure to be described later.

### DESCRIPTION OF DRAWINGS

FIG. 1 is a block diagram illustrating the main configuration of a water dispensing device according to an embodiment of the present disclosure.

FIG. 2 is a conceptual diagram illustrating a water dispensing device according to an embodiment of the present disclosure.

FIGS. 3 to 5 are diagrams for reference in describing the operation of the water dispensing device of FIG. 2.

FIG. 6 is a conceptual diagram illustrating a water dispensing device according to an embodiment of the present disclosure.

FIG. 7 is a diagram for reference in describing hygiene management standards for a water dispensing device according to an embodiment of the present disclosure.

FIG. 8 is a flowchart of an operation method of a water dispensing device according to an embodiment of the present disclosure.

FIG. 9 is a flowchart of an operation method of a water dispensing device according to an embodiment of the present disclosure.

FIGS. 10 to 12 are diagrams for reference in describing sterilization of a water dispensing device according to an embodiment of the present disclosure.

FIG. 13 is a diagram for reference in describing turbidity standards of various countries and information provision based thereon.

### MODE FOR DISCLOSURE

Hereinafter, the exemplary embodiments of the present disclosure are described in detail with reference to the accompanying drawings. The present disclosure may, however, be embodied in many different forms and should not be construed as being limited to the embodiments set forth herein.

In order to clearly and briefly describe the present disclosure, the parts irrelevant to the description are omitted in the drawings. The same reference numerals are used to designate the same or similar parts throughout the specification.

With respect to constituents used in the following description, the suffixes “module” and “unit” are merely given in consideration of only facilitation of description and do not have any special importance or role. Accordingly, the “module” and the “unit” may be used interchangeably.

In addition, it will be understood that, although the terms “first”, “second”, etc. may be used herein to describe various elements, these elements should not be limited by these terms. These terms are only used to distinguish one element from another element.

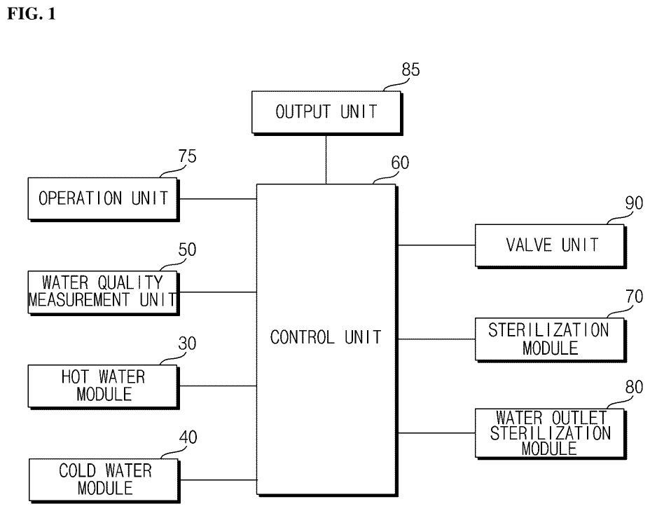

FIG. 1 is a block diagram illustrating the main configuration of a water dispensing device according to an embodiment of the present disclosure.

Referring to FIG. 1, the water dispensing device according to an embodiment of the present disclosure includes a water quality measurement unit 50. The water quality measurement unit 50 may include a turbidity sensor. According to an embodiment of the present disclosure, turbidity (contamination level) may be sensed through optical sensing. The optical sensing method for measuring turbidity uses a transmitted light method and a scattered light method. The transmitted light method senses turbidity by irradiating light on a fluid, receiving light transmitted through the fluid, and processing data. The scattered light method senses turbidity by receiving scattered light and processing data, and is subdivided according to a method of generating scattered light and a method of processing the data received by light. The turbidity sensor according to an embodiment of the present disclosure may irradiate light to the raw water or a portion of the purified water and sense turbidity based on a pattern of scattered light received. According to an embodiment of the present disclosure, particles and microorganisms are distinguished by patterning the intensity and movement of light scattered by microorganisms, and the types of water quality/hygiene standard indicator microorganisms are distinguished by big data processing. In addition, the sensed microbial concentration values and safety indicators are provided through a display so that a user may intuitively check the same.

In addition, the water quality measurement unit 50 may utilize water quality measurement sensors such as the turbidity sensor, a microbial sensor, and a TDS sensor to sense water quality contamination of water within a passage. The water quality measurement unit 50 may include at least one of the turbidity sensor, a microorganism detection sensor, a chlorine sensor, a total dissolved solids (TDS) sensor, or a BOD (biochemical oxygen demand) sensor, and may measure at least one of turbidity, microorganisms, residual chlorine, TDS, or dissolved oxygen of entering water. At least one of the sensors provided in the water quality measurement unit 50 may be a common sensor that measures the water qualities of both raw water and purified water.

In this specification, the entering of purified water or raw water in the water quality measurement unit 50 does not mean only that purified water or raw water enters inside the water quality measurement unit 50. For example, a portion of the purified water or raw water may be sampled and discharged after measuring the water quality inside the water quality measurement unit 50. In addition, at least some of the sensors provided in the water quality measurement unit 50 may measure the water quality of a flowing liquid. In this case, the entering of purified water or raw water in the water quality measurement unit 50 may mean that at least a portion of the purified water or raw water passes through the sensible section of the water quality measurement unit 50.

For example, in the case where the turbidity sensor has an internal chamber, the turbidity sensor may measure water quality by irradiating light on the filled water and receiving a scattered light pattern when water enters the internal chamber connected to a passage 20 and is filled. In addition, the water in the internal chamber may be discharged after measuring the water quality. Alternatively, a light source unit and a light receiving unit of the turbidity sensor may be disposed in a specific passage section (for example, a section after the purified water passage 20 and a sensing passage 12 are joined) to irradiate light to purified water or raw water passing through the specific passage section and receive a scattered light pattern.

The water dispensing device according to an embodiment of the present disclosure may measure the water quality of raw water and purified water using the common sensor for the same measurement item, such as turbidity. The turbidity sensor measures the turbidity of raw water and purified water, and transmits the sensing data to a control unit 60. The control unit 60 may control other configurations of the water dispensing device based on sensing data from the water quality measurement unit 50 such as the turbidity sensor.

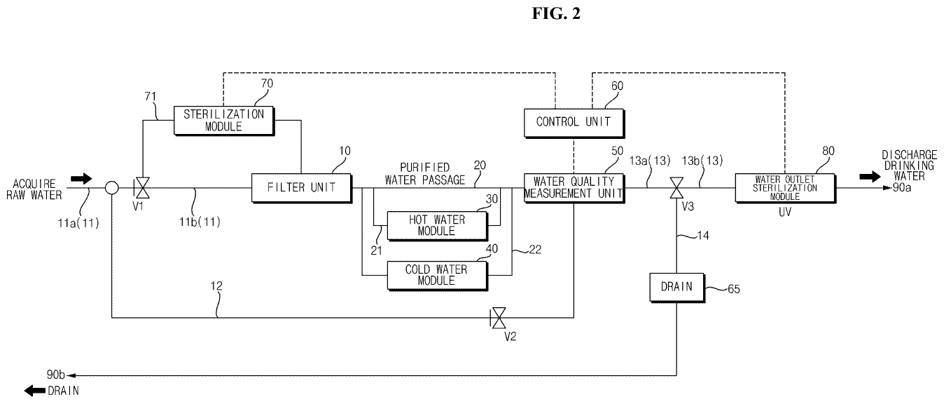

The water dispensing device includes a filter 10 (FIG. 2) that filters the raw water supplied from a water supply source to produce purified water. The filter 10 is for purification of supplied raw water and filters out various impurities and harmful substances contained in the raw water. One or more filters 10 may be provided, and in a case where a plurality of filters are provided, the filter 10 may be configured to combine filters with various functions. For example, the filter 10 may be provided in three pieces, and may include a pre-carbon filter and a post-carbon filter, and a membrane filter or a hollow fiber membrane filter disposed between the pre-carbon filter and the post-carbon filter. Alternatively, the filter 10 may be configured of a pre-carbon filter and a UF composite filter.

The purified water purified from the filter 10 flows to a storage tank or the passage 20 (FIG. 2). Since water stored in the storage tank becomes a better environment for microbial growth over time, it is more desirable to flow directly through the passage 20. The purified water that has passed through the filter 10 flows into the purified water passage 20.

In addition, the water dispensing device comprises a valve unit 90 having valves for controlling the flow of water. The valve unit 90 may include a plurality of valves V1, V2, V3 to be described below.

When the water quality measurement unit 50 measures the water quality of the raw water, the control unit 60 may control the valve unit 90 to perform a rinse operation in which the purified water passes through the water quality measurement unit 50 at least once.

The water quality measurement unit 50 may minimize the influence of raw water on the measurement of the water quality of the purified water by measuring the water quality of the purified water after performing the rinse operation. Accordingly, a single water quality sensor of the same type may efficiently and accurately sense both raw water and purified water.

In the case of tap water and purified outlet water, the water quality contamination level is normally low. In order to measure a low-concentration contamination level, it is important to minimize the occurrence of deviation in the measurement values. According to an embodiment of the present disclosure, compared to a technology that measures raw water and outlet water separately, a passage configuration and control capable of simultaneously measuring raw water and outlet water using one sensor is provided, thereby minimizing an increase in material costs and enabling a compact product configuration.

Since the tap water quality (raw water) and water purifier quality (purified water) are mostly in a low-concentration section, it is most important to minimize measurement deviation between devices by comparison with a single sensor in order to clearly express the difference in performance between raw water and outlet water.

In addition, the water dispensing device may include a hot water module 30 and a cold water module 40 for providing hot and cold water. The hot water module 30 heats purified water and then discharges the same toward a water outlet 90a (FIG. 2). The cold water module 40 cools the purified water and then discharges the same toward the water outlet 90a.

In addition, the water dispensing device further includes an operation unit 75 and an output unit 85.

The operation unit 75 may include one or more buttons for receiving user input. For example, the operation unit 75 may be provided with a touch panel and may include a capacity button for selecting a water outlet capacity, a hot water button for selecting hot water and further selecting the temperature of hot water to be released, a purified water button for selecting purified water, a cold water button for selecting cold water, and other function buttons.

The output unit 85 may be provided with a display device such as a display (not shown) or a light emitting diode (LED) (not shown). For example, the output unit 85 may display information such as the driving state of the water dispensing device, the operation state related to the occurrence of an error, or the contamination level of water.

The output unit 85 may be provided with an audio device such as a speaker (not shown) or a buzzer (not shown). For example, the output unit 85 may output a sound effect regarding the driving state of the water dispensing device and may output a predetermined warning sound when an error occurs.

In addition, the water dispensing device includes one or more modules for hygiene. For example, the water dispensing device includes a sterilization module 70 using high temperature water. In addition, the water dispensing device includes a water outlet sterilization module 80 for sterilizing the water outlet 90a where contamination is highly likely to occur.

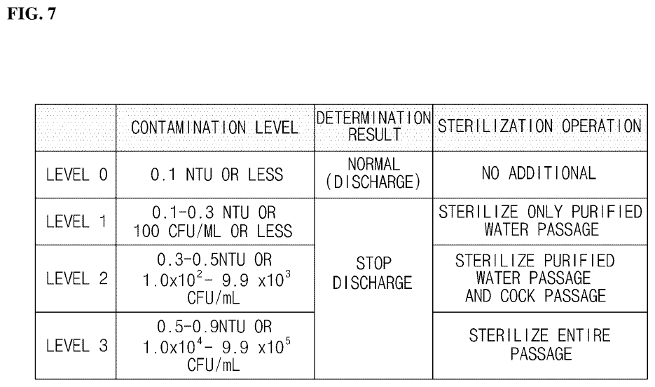

The sterilization module 70 may sterilize bacteria growing in water by instantly heating the water to a high temperature. In addition, the control unit 60 may operate the sterilization module 70 and circulate the sterilizing water (high temperature water) from the sterilization module 70 to another passage to sterilize the passage. The control unit 60 may control the high temperature water discharged from the sterilization module 70 to move to different passage regions based on the water quality data measured by the water quality measurement unit 50 and perform a sterilization operation for each passage region. The sterilization operation by a passage region is described in detail later with reference to FIGS. 7 to 13.

The water outlet sterilization module 80 irradiates ultraviolet rays toward the water outlet 90a to remove bacteria or viruses. The water outlet sterilization module 80 may include at least one ultraviolet (UV) lamp or at least one UV light emitting diode (LED).

The water outlet sterilization module 80 may be driven periodically under the control of the control unit 60. In addition, the water outlet sterilization module 80 may be driven for a predetermined period of time before water outlet. More preferably, the control unit 60 may improve efficiency by driving the water outlet sterilization module 80 only when necessary based on water quality data measured by the water quality measurement unit 50. For example, the control unit 60 may control the water outlet sterilization module 80 based on the water quality measurement results of purified water.

The control unit 60 may be connected to each component provided in the water dispensing device. For example, the control unit 60 can transmit and/or receive signals between each component provided in the water dispensing device and control the overall operation of each component.

The control unit 60 may include at least one processor, and may control the overall operation of the water dispensing device using the processor included therein. Herein, the processor may be a general processor such as a central processing unit (CPU). The processor may be a dedicated device such as an ASIC, or may be any of other hardware-based processors.

The control unit 60 may perform various calculations based on data received through the water quality measurement unit 50 including various sensors such as the turbidity sensor 51. In addition, the control unit 60 may store data received through the water quality measurement unit 50 in a memory (not shown).

The water quality measurement unit 50 may measure water quality and output the same to the control unit 60. The control unit 60 may be controlled to perform a feedback operation in response to water quality measurement data of raw water and/or purified water. Alternatively, the water quality measurement unit 50 may directly discriminate a contamination level and transmit the same to the control unit 60, and the control unit 60 may control other components to perform appropriate feedback operations based on the received contamination level.

The control unit 60 may control the output unit 85 to recognize the contamination state of raw water and/or purified water and provide a user with information on a cleaning alarm or filter replacement cycle.

In addition, the control unit 60 may sense in advance any odor that may occur depending on the contamination level of raw water and/or purified water, and operate the automatic washing/sterilization logic through the sterilization module 70 and the water outlet sterilization module 80 before the customer feels so. Accordingly, the convenience and hygiene of use for non-professional users may be improved.

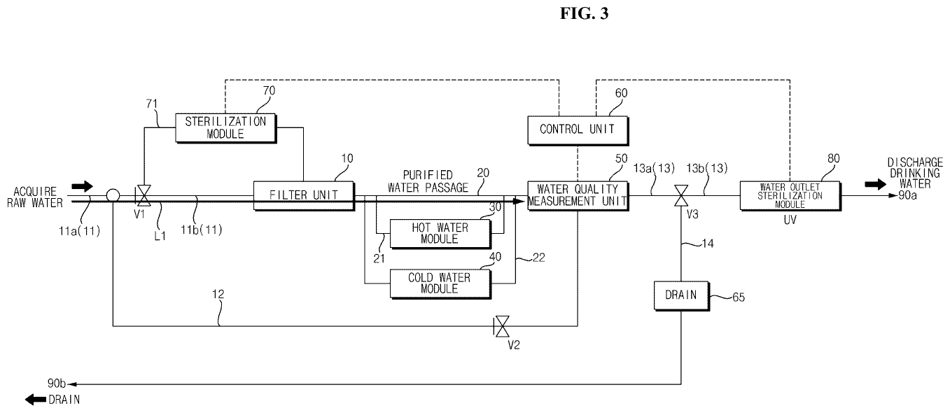

FIG. 2 is a conceptual diagram illustrating a water dispensing device according to an embodiment of the present disclosure. FIGS. 3 to 5 are diagrams for reference in describing the operation of the water dispensing device of FIG. 2.

Referring to FIG. 2, the water dispensing device includes the water supply passage 11 through which raw water supplied from the water supply source flows, and the filter unit 10 that filters the raw water supplied to the water supply passage 11 to produce purified water.

The purified water that has passed through the filter unit 10 flows through the purified water passage 20 toward the water outlet 90a. The purified water that has passed through the filter unit 10 may enters the water quality measurement unit 50. The water quality measurement unit 50 may measure the water quality of purified water when the purified water enters.

In addition, the sensing passage 12 is diverged from the water supply passage 11, so that raw water may directly enter the water quality measurement unit 50 through the sensing passage 12. The water quality measurement unit 50 may measure the water quality of raw water when the raw water enters.

According to an embodiment of the present disclosure, a water supply valve V1 that controls the water supply to the filter unit 10 and the purified water passage 20 may be disposed in the water supply passage 11. The water supply valve V1 may open and close the purified water passage 20. When the water supply valve V1 is opened, raw water may be purified through the filter unit 10 along a first line L1 of FIG. 3, and purified water may enter the water quality measurement unit 50 through the purified water passage 20.

The water supply passage 11 may include a first water supply passage 11a connecting the water supply source and the water supply valve V1, and a second water supply passage 11b connecting the water supply valve V1 and the filter 10.

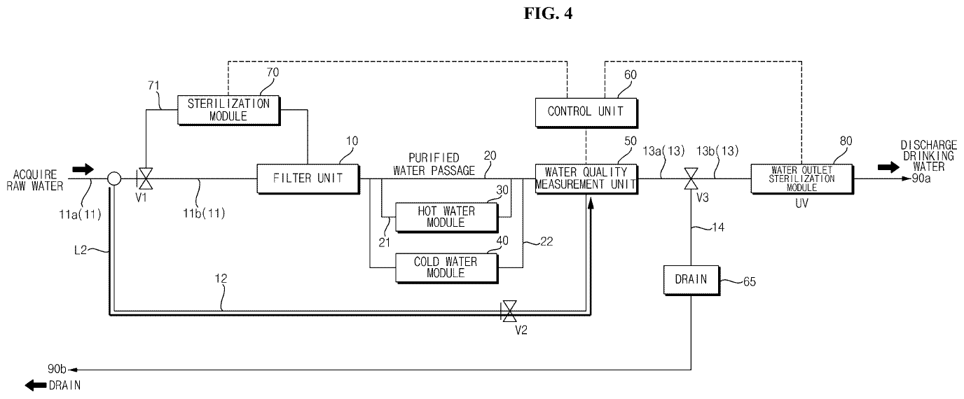

In addition, one end of the sensing passage 12 may be connected to the first water supply passage 11a, and the other end thereof may be connected to the water quality measurement unit 50. A sensing valve V2 that opens and closes the sensing passage 12 may be disposed in the sensing passage 12. When the sensing valve V2 is opened, raw water may directly enter the water quality measurement unit 50 through the sensing passage 12 along a second line L2 of FIG. 4.

Referring to FIG. 2, the water dispensing device may further include: the water outlet 90a through which the purified water is discharged; a water outlet passage 13 guiding the purified water to the water outlet 90a; a drainage passage 14 diverged from the water outlet passage 13 between the water quality measurement unit 50 and the water outlet 90a through which the raw water or the purified water is drained; and a water outlet valve V3 selectively supplying the raw water or the purified water to the water outlet passage 13 and the drainage passage 14.

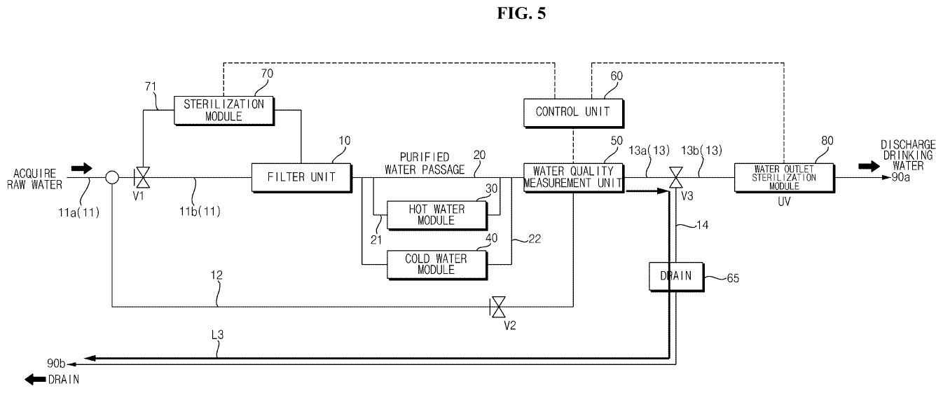

The water outlet valve V3 may, under the control of the control unit 60, divert water for which water quality measurement is completed to a drain 90b and the water outlet 90a. When the drainage operation is performed, the water for which water quality measurement is completed is allowed to flow in the drainage passage 14 along a third line L3 of FIG. 5. By draining and washing raw water, the raw water may be prevented from being released as drinking water.

The water outlet passage 13 may include a first water outlet passage 13a connecting the water quality measurement unit 50 and the water outlet valve V3, and a second water outlet passage 13b connecting the water outlet valve V3 and the water outlet 90a.

On the side of the water outlet 90a through which the purified water is discharged, the water outlet sterilization module 80 that irradiates ultraviolet rays to the water outlet 90a is disposed. The water outlet sterilization module 80 may sterilize a water outlet space and residual water. The control unit 60 may operate the water outlet sterilization module 80 for a predetermined time based on the water quality data measured by the water quality measurement unit 50.

Referring to FIG. 2, a sterilization passage 71 has one side diverged from the water supply passage 11 and the other side connected to the filter 10, and the sterilization module 70 that heats water passing through the sterilization passage 71 is disposed in the sterilization passage 71. The control unit 60 may operate the sterilization module 70 for a predetermined time based on the water quality data measured by the water quality measurement unit 50.

According to an embodiment of the present disclosure, the water supply valve V1 may be a switching valve that selectively supplies the raw water to the water supply passage 11 or the sterilization passage 71.

Referring to FIG. 2, the water dispensing device may further include: a hot water passage 21 diverged from the purified water passage 20 at one side; the hot water module 30 provided on the hot water passage 21 to heat purified water passing through the hot water passage 21; a cold water passage 22 diverged from the purified water passage 20 at one end side; and a cold water module 40 provided on the cold water passage 22 to cool purified water passing through the cold water passage 22.

Referring to FIG. 2, the hot water passage 21 and the cold water passage 22 may be joined again to the purified water passage 2. Alternatively, the hot water passage 21 and the cold water passage 22 may be joined to the water outlet passage 13.

According to an embodiment of the present disclosure, a drainage pump 65 may be disposed in the drainage passage 14. After measuring the water quality, when the drainage pump 65 operates, the water whose water quality has been measured may be discharged to the outside at a faster speed.

In addition, the drainage pump 65 may operate while the sterilization operation for each passage region is performed. Accordingly, the high temperature water may be discharged to the outside more quickly after sterilization. In particular, when the water outlet passage 13 connected to the cock on the water outlet 90a is also sterilized, a portion of the high temperature water is discharged toward the water outlet 90a, but a large amount of the high temperature water may be discharged toward the drain 90b. Accordingly, the occurrence of safety accidents, discomfort to users, and the inconvenience of users having to handle a large amount of hot water may be prevented as a large amount of hot water is discharged through the water outlet 90a.

The water quality measurement unit 50 measures the water quality of the purified water when the purified water enters through the purified water passage 20, and measures the water quality of the raw water when the raw water enters through the sensing passage 12.

When the water quality measurement unit 50 measures the water quality of the raw water, the water quality of the purified water may be measured after performing a rinse operation in which the purified water passes through at least once. As such, the sensing accuracy and efficiency may be improved by a water pipe configuration and a rinse operation for sensor publicization.

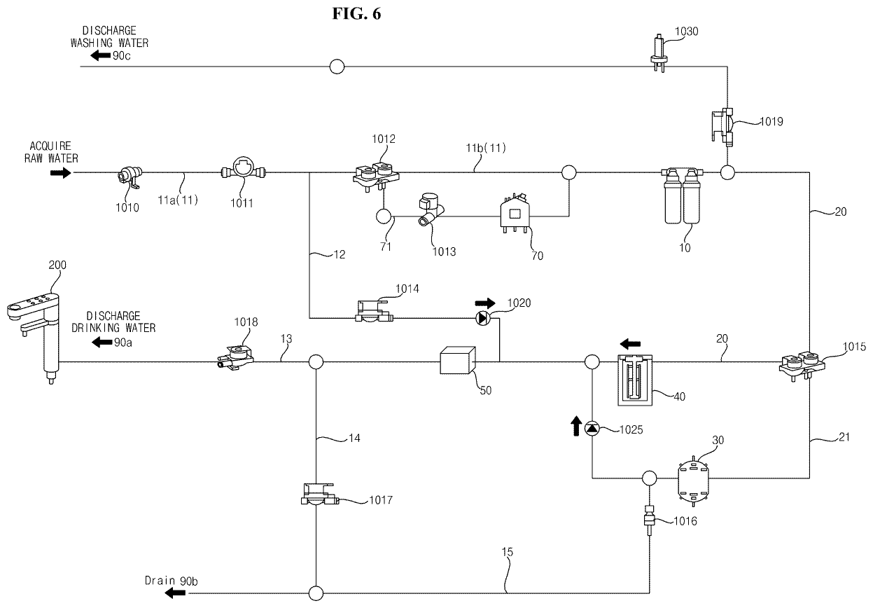

FIG. 6 is a conceptual diagram illustrating a water dispensing device according to an embodiment of the present disclosure, and illustrates a water pipe of the water dispensing device according to an embodiment of the present disclosure.

The water dispensing device according to an embodiment of the present disclosure may correspond to various water treatment apparatuses and purification apparatuses, such as water purifiers and refrigerators where water enters from the outside, purify the entered water, and then discharge the purified water.

As an example, the water dispensing device may be provided with an under sink type water purifier in which at least a portion is disposed in the lower space of a sink.

Referring to FIG. 6, the water dispensing device according to an embodiment of the present disclosure may include a water outlet 200 installed so that at least a portion thereof is exposed to the outside of the sink and a remaining main body unit installed on the inside of the sink.

The water dispensing device includes the water supply passage 11 that guides raw water supplied from the outside to the inside, the filter 10 that purifies the raw water supplied along the water supply passage 11 into purified water, and the purified water passage 20 that causes purified water passing through the filter 10 to flow toward the water outlet 200.

The water supply passage 11 connects an external water supply source and the filter 10. Through the water supply passage 11, raw water supplied from the external water supply source may be supplied to the filter 10.

As described above, water (raw water) supplied to the filter 10 is purified into purified water by passing through the filter 10. At least one of the filters 10 may be provided. For example, a plurality of filters 10 may be provided. Accordingly, water passing through the water supply passage 11 may be purified into cleaner water by passing through the plurality of filters 10.

In addition, purified water passing through the filter 10 may flow through the purified water passage 20 toward the water outlet 200 exposed on the outside of the sink 10.

To this end, one end of the purified water passage 20 is connected to the filter 10, and the other end is connected to the water outlet 200. In the purified water passage 20, at least one of the cold water passage 22, the hot water passage 21, or a washing water passage 90c may be diverged.

In FIG. 6, the cold water passage 22 is integrated into the purified water passage 20, and an example is illustrated in which the hot water passage 21 and the washing water passage 90c are diverged from the purified water passage 20.

One end of the purified water passage 20 is connected to the filter 10, and water passing through the filter 10 flows toward the water outlet 200 through the connected water outlet passage 13. The water outlet 200 includes the water outlet 90a and may take out purified water.

In addition, water diverged into the washing water passage 90c may be supplied to a washing water outlet in the state of sterilized water while passing through a washing water module 1030 provided on the washing water passage 90c. In the case where the water outlet 200 includes a plurality of water outlets, the washing water outlet may also be formed in the water outlet 200 depending on an embodiment.

A pressure reducing valve 1010 for adjusting the flow rate of water supplied to the filter 10 may be installed in the water supply passage 11.

In addition, at least one of a flow sensor 1011 for sensing the flow rate of water, an inlet valve for adjusting the flow rate of water or regulating the flow of water, or a flow rate sensor (not shown) for sensing the flow rate of water may be installed in the water supply passage 11 or the purified water passage 20.

In addition, separate opening/closing valves for regulating water flow in each of the purified water passage 20, the hot water passage 21, and the washing water passage 90c may be installed. For example, a washing water valve 1019 may be disposed in the washing water passage 90c.

Alternatively, a cold/hot/purified water valve 1015 that may selectively supply purified water to the purified water passage 20 and the hot water passage 21 may be installed at a diverge point of the purified water passage 20 and the hot water passage 21.

In addition, a device 1025 for safety such as backflow prevention may be installed in the hot water passage 21. In addition, a safety valve 1016 for steam discharge may be installed in the hot water module 30. The steam from the hot water module 30 may be drained toward the drain 90b through the connected passage 15.

A water outlet valve 1018 may be disposed in the water outlet passage 13 to supply or block purified water, cold water, and hot water flowing toward the water outlet 200 to the water outlet 200.

In addition, the drainage passage 14 is diverged from the water outlet passage 13, and a drain valve 1017 is disposed in the drainage passage 14 so that purified water, cold water, hot water, and raw water may be discharged toward the drain 90b.

As an example, the water outlet valve 1018 and the drain valve 1017 may be provided as a three-way valve having one inlet, a first outlet and a second outlet that are selectively opened, and an actuator that selectively opens and closes the two outlets. In this connection, the first outlet may be connected to the water outlet 200, and the second outlet may be connected to the drain 90b.

Raw water is supplied through the water supply passage 11 connected to the water supply source such as a tap water pipe, a water tank, or an underground water pipe. The pressure reducing valve 1010 is installed in the water supply passage 11, and the raw water is reduced to a set pressure while passing through the pressure reducing valve 1010.

In addition, the raw water that passes through the filter 10 becomes purified with foreign substances removed. The purified water flows along the purified water passage 20. In addition, the purified water may be diverged into cold-purified water and hot water.

First, the purified water diverged into the cold-purified water is diverged again into cold water and purified water. Depending on the operation of the cold water module 40 corresponding to the purified water or cold water selection manipulation of a user, the purified water or cold water may be supplied to the user through the water outlet 200.

When a user requests the release of cold water, purified water passes through a cooling coil inside the cold water module 40. The water flowing along the cooling coil exchanges heat with the coolant inside the cold water module 40 and is cooled into cold water. To this end, the coolant is continuously cooled to maintain a set temperature. For reference, a compressor may be driven to cool the coolant. The driving of the compressor may be determined by a cold water temperature sensor provided inside the cold water module 40. Accordingly, the coolant may always maintain a set temperature, and to this end, the driving of the compressor may be adjusted. The compressor is an inverter compressor, and its frequency is adjusted in response to the required load, and its cooling capacity may be adjusted. In other words, the compressor may be driven by inverter control and cool the coolant at optimal efficiency.

When a user requests the release of hot water, the purified water may be heated to a set temperature while passing through the hot water module 30. The hot water module 30 may be heated by induction heating, and to this end, the output of the working coil included in the hot water module 30 may be adjusted. The purified water passing through the hot water module 30 may be heated to a set temperature. The heated hot water passes through the hot water module 30 and flows toward the water outlet 200.

The sterilization passage 71 has one side diverged from the water supply passage 11 and the other side connected to the filter 10. In the sterilization passage 71, a sterilization module 70 that heats water passing through the sterilization passage 71 and a flow rate adjustment valve 1013 that controls the flow rate of the sterilization passage 71 may be disposed.

At a location where the sterilization passage 71 is diverged from the water supply passage 11, a feed valve 1012 that selectively supplies the raw water to the water supply passage 11 or the sterilization passage 71 may be disposed.

The water supply passage 11 may include the first water supply passage 11a connecting the water supply source and the feed valve 1012, and the second water supply passage 11b connecting the feed valve 1012 and the filter 10.

The sensing passage 12 described above may be diverged in the first water supply passage 11a at a front end of the feed valve 1012. A sensing valve 1014 that opens and closes the sensing passage 12 and a backflow prevention device 1020 that prevents backflow of raw water may be disposed in the sensing passage 12.

The control unit 60 may control the feed valve 1012 to be closed and the sensing valve 1014 to be opened so that raw water is supplied to the water quality measurement unit 50 through the sensing passage 1014.

After measuring the water quality of raw water, the control unit 60 closes the water outlet valve 1018 and opens the drain valve 1017 to discharge the raw water measured by the water quality measurement unit 50 toward the drain 90b.

The control unit 60 may control the feed valve 1012 to open toward the purified water passage 20 and the sensing valve 1014 to close so that purified water is supplied to the water quality measurement unit 50.

In addition, the control unit 60 closes the water outlet valve 1018 and opens the drain valve 1017 to perform a rinse operation by controlling the purified water passing through the water quality measurement unit 50 to be discharged toward the drain 90b.

Thereafter, the control unit 60 may measure the water quality of purified water by supplying purified water to the water quality measurement unit 50 with the same valve control. Accordingly, the influence of the raw water may be removed and the water quality of the purified water may be accurately measured in the same water quality measurement unit 50.

The water dispensing device according to an embodiment of the present disclosure moves high temperature water discharged from the sterilization module 70 to different passage regions based on the water quality data measured by the water quality measurement unit 50, thereby performing a sterilization operation for each passage region.

FIG. 7 is a diagram for reference in describing hygiene management standards for a water dispensing device according to an embodiment of the present disclosure. FIG. 7 is a diagram illustrating an example of hygiene management standards set according to contamination level reference values and sterilization operations by each passage region.

Referring to FIG. 7, the control unit 60 determines that the contamination level is normal at level 0 and proceeds with the general discharge mode, and stops the discharge when the contamination level is at levels 1 to 3 and performs a sterilization operation by specifying a passage region suitable for each contamination level. The sterilization algorithm according to an embodiment of the present disclosure is more efficient than the existing sterilization algorithm that performs overall sterilization without distinguishing the passage, in that the sterilization region is distinguished.

Contamination levels may be classified into reference values decided based on drinking water quality standards in each country, including Republic of Korea. For example, based on the domestic drinking water quality standards in the Republic of Korea, 100 CFU/mL may be set as a level 1 standard. When the contamination level is 100 CFU/mL or less, the contamination level is level 1, and the control unit 60 may control the sterilization of only the purified water passage 20.

Generally, levels up to several hundred to several thousand CFU/mL may be determined as contamination requiring hygiene management. When the water stagnates for a long time due to non-use and is affected by internal biofilm formation, the contamination level increases to 10,000 CFU/mL, and there is a risk of detection of general bacteria. Accordingly, 10,000 CFU/mL may be set as a higher contamination reference value. 10000 CFU/mL may be set as a standard of level 2.

When the contamination level is 10,000 CFU/mL or less, the contamination level is level 2, and the control unit 60 may control the purified water passage 20 and the water outlet passage 13 to be sterilized. The water outlet passage 13 is a passage that connects to the cock of the water outlet 200 and may also be called a cock passage. In addition, when the contamination level exceeds 10,000 CFU/mL, the contamination level is level 3, and the control unit 60 may control the entire passage to be sterilized.

In this specification, the terms “or higher” and “exceeding” are interchangeable, and the terms “less than” and “or less” are interchangeable. For example, when the contamination level is less than 100 CFU/mL, it may be discriminated as contamination level 1, when the contamination level is less than 10,000 CFU/mL, it may be discriminated as contamination level 2, and when the contamination level is 10,000 CFU/mL or higher, it may be discriminated as contamination level 3.

Alternatively, the reference values for distinguishing contamination levels may be decided based on the drinking water turbidity water quality standards of each country, including Republic of Korea. For example, contamination levels may be distinguished based on 0.1, 0.3, and 0.5 nephelometry turbidity units (NTU).

When the contamination level is 0.1 NTU or less (less than), it may be discriminated as contamination level 0. When the contamination level exceeds 0.1 NTU (or higher) and is 0.3 NTU or less (or less than), it may be discriminated as contamination level 1. When the contamination level exceeds 0.3 NTU (or higher) and is 0.5 NTU or less (or less than), it may be discriminated as contamination level 2. When the contamination level exceeds 0.5 NTU (or higher) and is 0.9 NTU or less (or less than), it may be discriminated as contamination level 3.

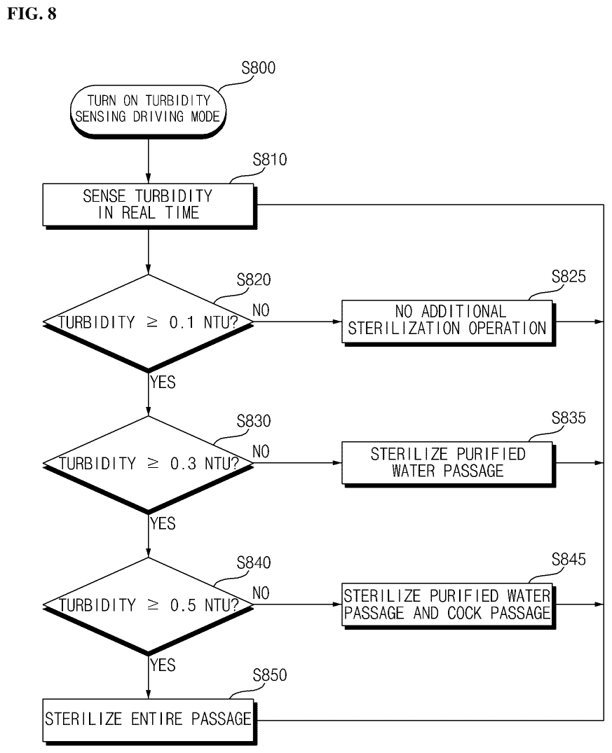

FIG. 8 is a flowchart of an operation method of a water dispensing device according to an embodiment of the present disclosure.

Referring to FIGS. 7 and 8, when the turbidity sensing driving mode is turned on (S800), the turbidity sensor of the water quality measurement unit 50 senses the turbidity of purified water passing through the filter 10 in real time (S810).

For example, when the turbidity is less than 0.1 NTU (S820), the contamination level is low at level 0, so the control unit 60 may control the water to discharge normally without performing additional sterilization operation (S825).

On the other hand, when the turbidity is 0.1 NTU or higher (S820) and the turbidity is less than 0.3 NTU (S830), the contamination level is level 1, and the control unit 60 may control the purified water passage 20 to be sterilized with high temperature water (S835).

When the turbidity is 0.3 NTU or higher (S830) and the turbidity is less than 0.5 NTU (S840), the contamination level is level 2, and the control unit 60 may control the purified water passage 20 and the water outlet passage 13 to be sterilized with high temperature water (S845).

When the turbidity is 0.5 NTU or higher (S840), the contamination level is level 3, and the control unit 60 may control the entire passage to be sterilized with high temperature water (S850).

According to an embodiment of the present disclosure, the passage is selected and sterilized based on the contamination level measured through the water quality measurement unit 50. Specific regions are sterilized, thus reducing the time required for sterilization.

In addition, while about 15 L of water is used when the entire sterilization operation is performed, it is saved to about 8 L or less when an individual passage sterilization operation is performed, thereby reducing the amount of water required for sterilization and enabling efficient management and driving of the water dispensing device from a long-term perspective.

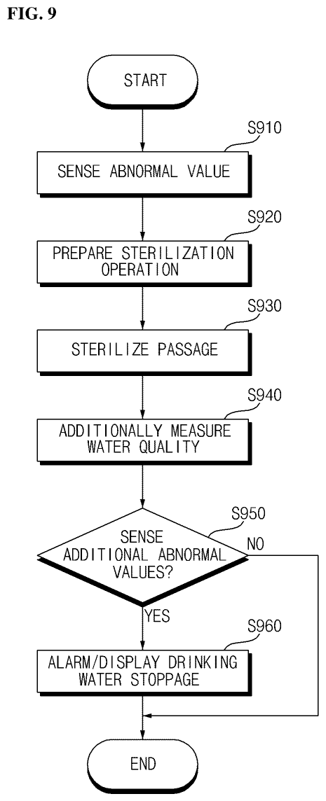

FIG. 9 is a flowchart of an operation method of a water dispensing device according to an embodiment of the present disclosure.

The water quality measurement unit 50 senses the contamination level of water in real time (S910). For example, the water quality measurement unit 50 senses turbidity included in the drinking water quality standard items in real time, and allows a user to know the water quality of the drinking water, thereby increasing user reliability.

When an abnormality in the contamination level is sensed (S910), the control unit 60 prepares a sterilization operation for sterilization of the passage corresponding to the contamination level (S920). For example, the control unit 60 operates the sterilization module 70 to produce high temperature water. In addition, the control unit 60 controls the valve unit 90 so that water is supplied to the sterilization module 70 through the sterilization passage 71 and high temperature water is supplied to the selected passage.

The control unit 60 supplies high temperature water from the sterilization module 70 to a passage corresponding to the contamination level to perform an automatic sterilization operation (S930).

Thereafter, the water quality measurement unit 50 additionally measures water quality (S940). When additional abnormal values are sensed (S950), the control unit 60 stops discharging drinking water, and the output unit 85 may alarm/display drinking water stoppage and water quality abnormality state (S960). Even after hygiene management, when an abnormal value is sensed, the control unit 60 may stop discharging drinking and issue an alarm and display information such as raw water management/filter replacement.

According to an embodiment of the present disclosure, when an abnormal value is sensed in water quality, the control unit 60 controls the passage requiring management according to the abnormal value to be sterilized for an appropriate amount of time through an automatic sterilization system. The control unit 60 may increase the sterilization operation time as the contamination level increases.

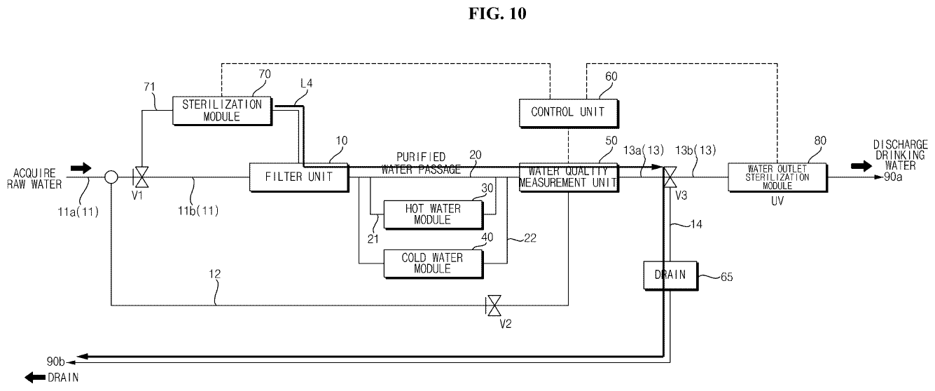

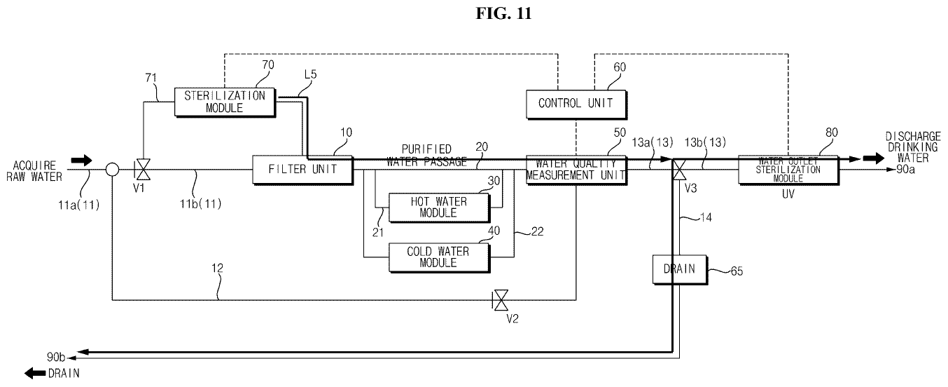

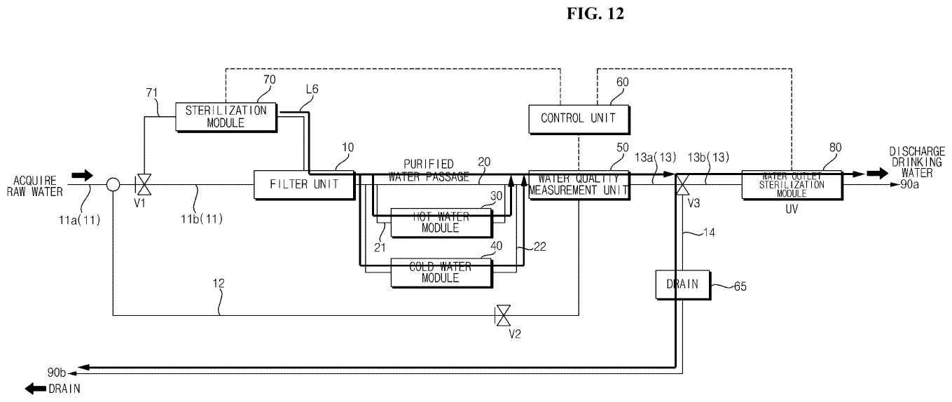

FIGS. 10 to 12 are diagrams for reference in describing sterilization of a water dispensing device according to an embodiment of the present disclosure. FIG. 10 illustrates a sterilization operation in level 1 of water contamination, FIG. 11 illustrates a sterilization operation in level 2 of water contamination, and FIG. 12 illustrates a sterilization operation in level 3 of water contamination.

Referring to FIGS. 10 to 12, the water dispensing device includes the water supply passage 11 through which raw water supplied from the water source flows, and the filter unit 10 that filters the raw water supplied to the water supply passage 11 to produce purified water.

The purified water that has passed through the filter unit 10 flows through the purified water passage 20 toward the water outlet 90a. The purified water that has passed through the filter unit 10 may enters the water quality measurement unit 50. The water quality measurement unit 50 may measure the water quality of purified water when the purified water enters.

The sterilization passage 13 may be diverged from the water supply passage 11. The sterilization passage 13 is diverged from the water supply passage 11 on one side and connected to the filter unit 10 on the other side. The sterilization module 70 is disposed in the sterilization passage 13 to produce high temperature water for sterilization.

The water dispensing device moves the high temperature water discharged from the sterilization module 70 to different passage regions based on the water quality data measured by the water quality measurement unit 50 and performs a sterilization operation for each passage region. Accordingly, the passage may be sterilized efficiently in a short period of time.

Referring to FIGS. 10 to 12, the water dispensing device includes: the water outlet 90a through which the purified water is discharged; the water outlet passage 13 guiding the purified water to the water outlet 90a; the drainage passage 14 diverged from the water outlet passage 13 between the water quality measurement unit 50 and the water outlet 90a through which the raw water or the purified water is drained; and the water outlet passage 13 of the raw water or the purified water.

The water outlet valve V3 is disposed in the water outlet passage 13 so that the raw water or purified water may be selectively supplied to the water outlet passage 13b and the drainage passage 14.

In addition, in the purified water passage 20, the hot water passage 21 and the cold water passage 22 are diverged. The hot water module 30 and the cold water module 40 for heating and cooling purified water are respectively disposed in the hot water passage 21 and the cold water passage 22.

When the water quality data measured by the water quality measurement unit 50 is higher than a first reference value, the purified water passage 20 may be sterilized with the high temperature water discharged from the sterilization module 70. When the water quality data measured by the water quality measurement unit 50 is higher than the first reference value (for example, 0.1 NTU), the control unit 60 may discriminate the same as contamination level 1.

Referring to FIG. 10, in contamination level 1, the control unit 60 may control the purified water passage 20 to be sterilized with high temperature water discharged from the sterilization module 70. Along a fourth line L4, high temperature water sterilizes the purified water passage 20 and is drained to the drainage passage 14.

In addition, when the water quality data measured by the water quality measurement unit 50 is higher than the first reference value, the discharge from the water outlet may be stopped. The control unit 60 may control the discharge to resume after selectively sterilizing the passage in response to the contamination level while the discharge of drinking water is stopped.

When the water quality data measured by the water quality measurement unit 50 is higher than a second reference value that is higher than the first reference value, the purified water passage 20 and the water outlet passage 13 may be sterilized with the high temperature water discharged from the sterilization module 70. When the water quality data measured by the water quality measurement unit 50 is higher than the second reference value (for example, 0.3 NTU), the control unit 60 may discriminate the same as contamination level 2.

Referring to FIG. 11, in contamination level 2, the control unit 60 may control the purified water passage 20 and the water outlet passage 13 to be sterilized with high temperature water discharged from the sterilization module 70. Along a fourth line L5, high temperature water sterilizes the purified water passage 20 and a portion thereof is drained to the drainage passage 14. In addition, a portion of the high temperature water sterilizes the water outlet passage 13 and is discharged through the water outlet 90a.

The water outlet passage 13 may include a first water outlet passage 13a connecting the water quality measurement unit 50 and the water outlet valve V3, and a second water outlet passage 13b connecting the water outlet valve V3 and the water outlet 90a.

The high temperature water from the sterilization module 90 flows to the purified water passage 20 and the first water outlet passage 13a, and sterilizes the purified water passage 20 and the first water outlet passage 13a. In addition, a portion of the high temperature water is drained to the drainage passage 14, and the remaining portion thereof sterilizes the second water outlet passage 13b and is discharged through the water outlet 90a.

When the water quality data measured by the water quality measurement unit 50 is higher than a third reference value that is higher than the second reference value, the entire passage may be sterilized with the high temperature water discharged from the sterilization module 70. The entire passage refers to the entire passage that may be sterilized with high temperature water and is a target for high temperature water sterilization, and does not refer to the entire passage of the water dispenser device. For example, the sensing passage 12 is not included in the entire passage during sterilization operation.

When the water quality data measured by the water quality measurement unit 50 is higher than the third reference value (for example, 0.5 NTU), the control unit 60 may discriminate the same as contamination level 3.

Referring to FIG. 12, in contamination level 3, the control unit 60 may control the purified water passage 20, the hot water passage 21, the cold water passage 22, and the water outlet passage 13 to be sterilized with the high temperature water discharged from the sterilization module 70. Along a sixth line L6, the high temperature water sterilizes the purified water path 20, the hot water path 21, and the cold water path 22, and a portion thereof is drained to the drainage passage 14. In addition, a portion of the high temperature water sterilizes the water outlet passage 13 and is discharged through the water outlet 90a.

The control unit 60 may stop the discharge and sterilize the passage when the contamination level corresponds to contamination levels 1 to 3, which is higher than the first reference value. In addition, the control unit 60 may distinguish the contamination level into contamination level 1 where the contamination level is higher than the first reference value and less than the second reference value, contamination level 2 where the contamination level is higher than the second reference value and less than the third reference value, and contamination level 3 where the contamination level is higher than the third reference value, and adjust the sterilization region for each contamination level.

The reference values for distinguishing the contamination levels, such as the first to third reference values, may be set as turbidity values based on domestic and overseas legal water quality standards.

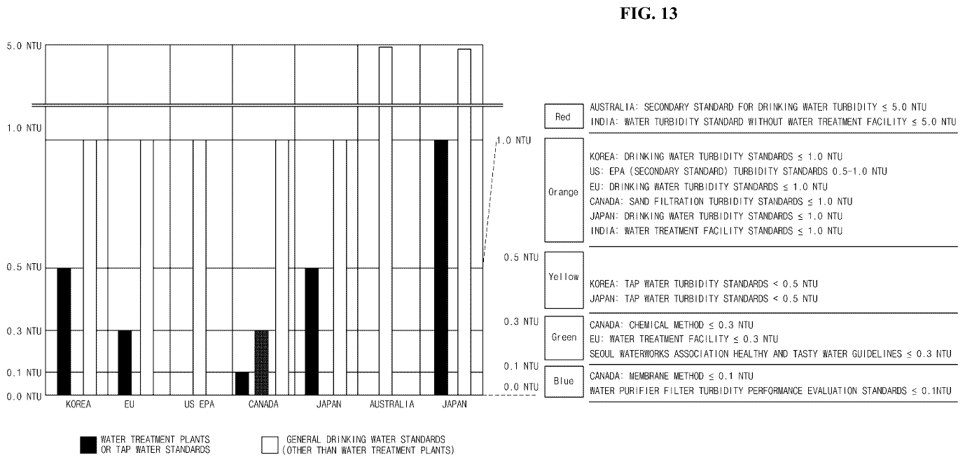

FIG. 13 is a diagram for reference in describing turbidity standards of various countries and information provision based thereon. Referring to FIG. 13, water treatment plants or general drinking water standards in Korea, EU, US, Canada, Japan, Australia, and India are illustrated. Based on the turbidity standards of each country, the contamination level may be distinguished and the passage may be selectively sterilized. In addition, the output unit 85 may provide turbidity information visualized in different colors depending on the turbidity numerical value.

According to an embodiment of the present disclosure, the contamination level of water may be sensed in real time, and the sterilization module may be operated by dividing the sterilization region (purified water passage, cold water passage, and faucet passage) accordingly, so that the hygiene of drinking water may be automatically managed efficiently without performing a sterilization operation on the entire passage region. This may minimize the amount of water required for sterilization and shorten the sterilization time.

The water outlet sterilization module 80 may also operate at a predetermined intensity for a predetermined time based on water quality data measured by the water quality measurement unit 50. For example, when the sterilization module 7 sterilizes the water outlet passage 13, the water outlet sterilization module 80 may also operate. In this connection, the water outlet sterilization module 80 may irradiate stronger ultraviolet rays as the contamination level increases.

The water quality measurement unit 50 may re-measure the water quality after performing the sterilization operation for each passage region. In addition, the output unit 85 may display water quality abnormality information when the water quality re-measurement result falls outside the preset normal range.

Hereinbefore, although preferred embodiments of the present disclosure have been illustrated and described, the present disclosure is not limited to the specific embodiments described above, and it goes without saying that persons having ordinary skills in the technical field to which the present disclosure pertains may implement the present disclosure by various modifications thereof without departing from gist of the present disclosure defined by the claims, and such modifications are not to be construed individually from the technical spirit and scope of the present disclosure.

1. A water dispensing device, comprising:
a water supply passage through which raw water supplied from a water supply source flows;
a filter which filters raw water supplied through the water supply passage to produce purified water;
a purified water passage through which purified water having passed through the filter flows;
a water quality measurement unit which is connected to the purified water passage and measures the water quality of the purified water;
a sterilization passage, one side of which is diverged from the water supply passage and the other side of which is connected to the filter; and
a sterilization module which is provided on the sterilization passage to heat water passing through the sterilization passage,
wherein, on the basis of water quality data measured by the water quality measurement unit, high temperature water discharged from the sterilization module is moved to different passage regions to perform a sterilization operation for each passage region.

2. The water dispensing device of claim 1, further comprising:
a water outlet through which the purified water is discharged;
a water outlet passage guiding the purified water to the water outlet; and
a drainage passage diverged from the water outlet passage between the water quality measurement unit and the water outlet through which the raw water or the purified water is drained.

3. The water dispensing device of claim 2, further comprising a water outlet valve selectively supplying the raw water or the purified water to the water outlet passage and the drainage passage.

4. The water dispensing device of claim 2, further comprising
a hot water passage diverged from the purified water passage at one side;
a hot water module provided in the hot water passage to heat purified water passing through the hot water passage;
a cold water passage diverged from the purified water passage at one side; and
a cold water module provided in the cold water passage to cool purified water passing through the cold water passage.

5. The water dispensing device of claim 4, wherein, when the water quality data measured by the water quality measurement unit is higher than a first reference value, the purified water passage is sterilized with the high temperature water discharged from the sterilization module.

6. The water dispensing device of claim 5, wherein, when the water quality data measured by the water quality measurement unit is higher than a second reference value that is higher than the first reference value, the purified water passage and the water outlet passage are sterilized with the high temperature water discharged from the sterilization module.

7. The water dispensing device of claim 6, wherein, when the water quality data measured by the water quality measurement unit is higher than a third reference value that is higher than the second reference value, the entire passage is sterilized with the high temperature water discharged from the sterilization module.

8. The water dispensing device of claim 5, wherein, when the water quality data measured by the water quality measurement unit is higher than the first reference value, discharge of the water outlet is stopped.

9. The water dispensing device of claim 4, wherein the hot water passage and the cold water passage are joined to the water outlet passage or joined again to the purified water passage.

10. The water dispensing device of claim 2, further comprising a water outlet sterilization module that irradiates ultraviolet rays to the water outlet, wherein the water outlet sterilization module operates for a predetermined time based on the water quality data measured by the water quality measurement unit.

11. The water dispensing device of claim 2, further comprising a drainage pump disposed in the drainage passage.

12. The water dispensing device of claim 11, wherein the drainage pump operates while the sterilization operation is performed for each of the passage regions.

13. The water dispensing device of claim 1, wherein the water quality measurement unit re-measures the water quality after performing the sterilization operation for each of the passage regions.

14. The water dispensing device of claim 13, further comprising an output unit that displays water quality abnormality information when the water quality re-measurement result is outside a preset normal range.

15. The water dispensing device of claim 1, further comprising a sensing passage diverged from the water supply passage and through which the raw water flows,
wherein the water quality measurement unit measures the water quality of the purified water when the purified water enters through the purified water passage and measures the water quality of the raw water when the raw water enters through the sensing passage.

16. The water dispensing device of claim 15, wherein the water quality measurement unit measures the water quality of the purified water after performing a rinse operation in which the purified water passes through at least once when measuring the water quality of the raw water.

17. The water dispensing device of claim 15, further comprising:
a switching valve for supplying the raw water to the water supply passage or the sterilization passage; and
a sensing valve for opening and closing the sensing passage.

18. The water dispensing device of claim 1, further comprising a control unit that controls to perform a feedback operation based on the water quality data measured by the water quality measurement unit.

19. The water dispensing device of claim 1, wherein the water quality measurement unit comprises a turbidity sensor that irradiates light to the raw water or a portion of the purified water and senses turbidity based on a pattern of scattered light received.
